(19) United States
(12) Patent Application Publication
(10) Pub. No.: US 2008/0245289 A1
(43) Pub. Date: Oct. 9, 2008

(54) Moisture Indicator and Time Indicator

(75) Inventor: Sumihiro Shiraishi, Yamatokoriyama-shi (JP)

Correspondence Address: FITCH, EVEN, TABIN & FLANNERY, P. O. BOX 18415, WASHINGTON, DC, 20036, US

(73) Assignee: QUALICAPS CO., LTD., Yamatokoriyama-shi (JP)

(21) Appl. No.: 11/964,804

(22) Filed: Dec. 27, 2007

Related U.S. Application Data
(60) Provisional application No. 60/877,392, filed on Dec. 28, 2006.
(60) Provisional application No. 60/945,194, filed on Jun. 20, 2007.

(51) Int. Cl. G01D 21/00

(52) U.S. Cl. 116/206

(57) ABSTRACT

The present invention provides a film or a sheet-like moisture indicator that allows one to visually recognize moisture by changing from a non-transparent color such as white to transparent when it is moistened. The present invention also provides a film or a sheet-like time indicator that allows one to visually recognize the passage of a predetermined length of time by becoming transparent when it is moistened.

The indicator of the invention has a water-soluble, non-transparent layer formed of a non-transparent, dry film composition, which comprises a water-soluble cellulose derivative, as well as a water-soluble compound containing at least one metal selected from the group consisting of monovalent, divalent, and trivalent metals. The indicator may further comprise, on the water-soluble, non-transparent layer, a water-soluble transparent layer, a water-insoluble support layer, and/or an attachment layer (an adhesive layer and a release paper therefor) for attaching the indicator to a test target.

### TECHNICAL FIELD

The present invention relates to a film or a sheet-like moisture indicator that allows one to visually recognize moisture by changing its color from a non-transparent color such as white to transparent when it is moistened. The present invention also relates to a film or a sheet-like time indicator that allows one to visually recognize the passage of a predetermined length of time by becoming transparent when it is moistened, and to applications thereof.

### BACKGROUND ART

Simple indicators that can identify the pH of a solution such as Litmus papers are in demand in a variety of fields. For example, various moisture indicators that indicate moisture by being colored or changing color in the presence of water or water vapor (moisture) have been devised (for example, Patent Documents 1 to 4) for application to water-absorbing articles such as diapers. Various time indicators that indicate the passage of time based on the coloration or change of colors due to a reaction with oxygen or reactions between chemical compounds have also been devised (for example, Patent Documents 5 and 6).

However, no time indicators that operate by becoming transparent when saturated with water have been devised.

Patent Document 1: Japanese Unexamined Patent Publication No. H9-105692

Patent Document 2: Japanese Unexamined Patent Publication No. 2005-15664

Patent Document 3: Japanese Unexamined Patent Publication No. 2005-185643

Patent Document 4: US Patent Publication No. 2007197986 (US 2007197986 A1)

Patent Document 5: Japanese Unexamined Patent Publication No. H11-14616

Patent Document 6: Japanese Unexamined Patent Publication No. H7-27878

### DISCLOSURE OF THE INVENTION

Instant foods cooked by adding hot water such as instant noodles packaged in cups are typically designed so that they are consumed in a certain period of time, such as 3, 4, or 5 minutes, after adding hot water. However, one does not necessarily carry a watch when he or she is eating an instant food; it would thus be very convenient to provide a time indicator with the container of an instant food, allowing him or her to visually recognize the passage of time after adding hot water. Time indicators of higher commercial value may also be provided by allowing a color or a print to appear when the time indicator has become transparent with the passage of time, instead of indicating the passage of time merely through coloration or a change of colors.

The present invention has been made based on these ideas. An object of the invention is to provide an indicator (moisture indicator) that indicates moisture by becoming transparent when contacting water or water vapor. Another object of the invention is to provide a simple time indicator that indicates the passage of time after contacting water by becoming transparent, utilizing the moisture indicator becoming transparent when contacting water or water vapor.

The present inventors conducted extensive research to solve the aforementioned problems. As a result, the inventors found that a film prepared by drying an aqueous solution comprising a water-soluble cellulose derivative and a monovalent, divalent, or trivalent metal ion to solidify the aqueous solution into a film or a sheet has a non-transparent color such as white when dried, but it becomes transparent when the film contacts with water or water vapor and is saturated with water; the inventors thus ascertained that the film is effective as a moisture indicator. In addition, the inventors found that the time required for the film to become transparent is correlated with the thickness of the film, thus ascertaining that the time required for the film to become transparent after contacting water can be adjusted to a desired length by adjusting the thickness of the film. On the basis of this finding, the inventors ascertained that the film for use as a moisture indicator is also effective as a time indicator that indicates a predetermined time.

The invention has been accomplished based on these findings, and include the following embodiments.

### I. Moisture Indicator

(I-1) A moisture indicator having a water-soluble, non-transparent layer formed of a non-transparent, dry film composition, the composition comprising a water-soluble cellulose derivative, as well as a water-soluble compound containing at least one metal selected from the group consisting of monovalent, divalent, and trivalent metals.

(I-2) A moisture indicator according to item (I-1), wherein the water-soluble, non-transparent layer is a water-soluble, non-transparent layer formed by drying an aqueous solution comprising a water-soluble cellulose derivative, as well as at least one metal ion selected from the group consisting of monovalent, divalent, and trivalent metal ions to solidify the aqueous solution into a film or a sheet.

(I-3) A moisture indicator according to item (I-1) or (I-2), wherein a water-soluble transparent layer is formed on at least one surface of the water-soluble, non-transparent layer.

(I-4) A moisture indicator according to any one of items (I-1) to (I-3), wherein a water-insoluble support layer is further formed on the water-soluble, non-transparent layer.

(I-5) A moisture indicator according to item (I-4), wherein the water-insoluble support layer is transparent.

(I-6) A moisture indicator according to item (I-4) or (I-5), wherein a portion or all of the water-insoluble support layer is dyed or printed.

(I-7) A moisture indicator according to item (I-5), which has a portion that does not become transparent when saturated with water.

(I-8) A moisture indicator according to any one of items (I-1) to (I-7), wherein an attachment layer is further formed on the water-soluble, non-transparent layer.

(I-9) A moisture indicator according to any one of items (I-4) to (I-7), wherein an attachment layer is further formed on the water-insoluble support layer.

(I-10) A moisture indicator according to item (I-8) or (I-9), wherein the attachment layer is covered with a release paper.

(I-11) A moisture indicator according to any one of items (I-4) to (I-10), wherein the water-insoluble support layer is a waterproof support layer (waterproof layer).

### II. Time Indicator and Application Thereof

(II-1) A time indicator having a water-soluble, non-transparent layer formed of a non-transparent, dry film composition, the composition comprising a water-soluble cellulose derivative, as well as a water-soluble compound containing at least one metal selected from the group consisting of monovalent, divalent, and trivalent metals.

(II-2) A time indicator according to item (II-1), wherein the water-soluble, non-transparent layer is a water-soluble, non-transparent layer formed by drying an aqueous solution comprising a water-soluble cellulose derivative, as well as at least one metal ion selected from the group consisting of monovalent, divalent, and trivalent metal ions to solidify the aqueous solution into a film or a sheet.

(II-3) A time indicator according to item (II-1) or (II-2), wherein a water-soluble transparent layer is formed on at least one surface of the water-soluble, non-transparent layer.

(II-4) A time indicator according to any one of items (II-1) to (II-3), wherein a water-insoluble support layer is further formed on the water-soluble, non-transparent layer.

(II-5) A time indicator according to item (II-4), wherein the water-insoluble support layer is transparent.

(II-6) A time indicator according to item (II-4) or (II-5), wherein a portion or all of the water-insoluble support layer is dyed or printed.

(II-7) A time indicator according to item (II-5), which has a portion that does not become transparent when saturated with water.

(II-8) A time indicator according to any one of items (II-1) to (II-7), wherein an attachment layer is further formed on the water-soluble, non-transparent layer.

(II-9) A time indicator according to any one of items (II-4) to (II-7), wherein an attachment layer is further formed on the water-insoluble support layer.

(II-10) A time indicator according to any one of items (II-1) to (II-9), which is used by bringing water or water vapor into contact with the water-soluble, non-transparent layer, and which measures the passage of time after contacting water, based on the water-soluble, non-transparent layer becoming transparent by contact with water or water vapor.

(II-11) A time indicator according to any one of items (II-3) to (II-9), which is used by bringing water or water vapor into contact with the water-soluble transparent layer, and which measures the passage of time after contacting water, based on the water-soluble, non-transparent layer becoming transparent by contact with water or water vapor.

(II-12) A time indicator according to any one of items (II-6) to (II-11), wherein the dyed or printed surface of the water-insoluble support layer appears when the water-soluble, non-transparent layer has become transparent by contact with water or water vapor.

(II-13) A container comprising the time indicator as defined in any one of items (II-1) to (II-12) in a portion thereof.

(II-14) A food packaged in a container, the container comprising the time indicator as defined in any one of items (II-1) to (II-12) in a portion thereof.

(II-15) A food packaged in a container according to (II-14), which is an instant food cooked by adding hot water or a food in a retort pouch.

The term “monovalent metals” as referred to herein means “metals with an ionic valence of 1”, “divalent metals” means “metals with an ionic valence of 2”, and “trivalent metals” means “metals with an ionic valence of 3”.

### BRIEF DESCRIPTION OF THE DRAWINGS

FIG. 1 shows, for each of the white films (thickness: 65 to 188 μm) prepared in Experimental Example 3 (Examples 1 to 8), the relationship between the thickness (μm) of the film and the time (min) required for the film to become transparent by contact with water.

FIG. 2 shows, for each of the two-layer films (with a thickness of 134 to 182 μm) formed of a water-soluble, non-transparent layer (thickness: 100 μm) and a water-soluble transparent layer (thickness: 34 to 82 μm) (Examples 9 to 13), the relationship between the thickness (μm) of the film and the time (min) required for the film to become transparent by contact with water (Experimental Example 4e).

FIG. 3 shows, for each of the non-transparent films prepared in Experimental Example 5 (using magnesium chloride), the relationship between the thickness (μm) of the film and the time (min) required for the film to become transparent by contact with water.

FIG. 4 shows, for each of the non-transparent films prepared in Experimental Example 6 (using calcium chloride), the relationship between the thickness (μm) of the film and the time (min) required for the film to become transparent by contact with water.

FIG. 5 is a diagram showing an embodiment of the indicator (the moisture indicator or time indicator) (reference numeral 1) of the invention (Example 14), which comprises a white layer (a water-soluble, non-transparent layer) (reference numeral 2) and a water-insoluble support layer (reference numeral 3) in sequence from above.

FIG. 6 is a diagram showing an embodiment of the indicator (the moisture indicator or time indicator) (reference numeral 1) of the invention (Example 15), which comprises a water-soluble transparent layer (reference numeral 4), a white layer (a water-soluble, non-transparent layer) (reference numeral 2), and a water-insoluble support layer (reference numeral 3) in sequence from above.

FIG. 7 is a diagram showing an embodiment of the indicator (the moisture indicator or time indicator) (reference numeral 1) of the invention (Example 16), which comprises a white layer (a water-soluble, non-transparent layer) (reference numeral 2), a water-insoluble support layer (reference numeral 3), and an attachment layer (reference numeral 5) (an adhesive layer (reference numeral 6) and a release paper (reference numeral 7)) in sequence from above.

FIG. 8 is a diagram showing an embodiment of the indicator (the moisture indicator or time indicator) (reference numeral 1) of the invention (Example 17), which comprises a water-soluble transparent layer (reference numeral 4), a white layer (a water-soluble, non-transparent layer) (reference numeral 2), a water-insoluble support layer (reference numeral 3), and an attachment layer (reference numeral 5) (an adhesive layer (reference numeral 6) and a release paper (reference numeral 7)) in sequence from above.

FIG. 9 is a schematic diagram showing an embodiment in which the window portion (reference numeral 8) formed of the time display sheet is provided in the lid (reference numeral 10) of the container (reference numeral 9) of an instant food cooked by adding hot water (such as noodles packaged in a cup); when hot water is added to the container (reference numeral 9), and the lid (10) is saturated with water vapor (reference numeral 11), the lid (reference numeral 10), which is initially non-transparent, becomes transparent (reference numeral 12), resulting in the appearance of the non-transparent print (“QKK” here) (reference numeral 13).

FIG. 10 shows three embodiments of the lid (reference numeral 10) shown in FIG. 9: FIG. 10(A) shows an embodiment in which the time display sheet having a water-insoluble support layer (waterproof layer, reference numeral 3), a water-soluble, non-transparent layer (reference numeral 2), and a water-soluble transparent layer (reference numeral 4) is disposed on the surface (upper surface) of the window portion (reference numeral 8) provided in the lid (reference numeral 10) (the time display sheet attached on the upper surface of the lid); FIG. 10(B) shows an embodiment in which the time display sheet is disposed on the rear surface (lower surface) of the window portion (reference numeral 8) provided in the lid (reference numeral 10) (the time display sheet attached on the lower surface of the lid); and FIG. 10(C) shows an embodiment in which the lid (reference numeral 10) is formed of a two-layer sheet, and the time display sheet is disposed between the sheets of the two-layer sheet of the window portion (reference numeral 8) provided in the lid (reference numeral 10) (the time display sheet attached between the sheets of the lid).

### BEST MODE FOR CARRYING OUT THE INVENTION

### I. Moisture Indicator

The moisture indicator of the invention has a water-soluble, non-transparent layer formed of a non-transparent, dry film composition, which composition comprises a water-soluble cellulose derivative, as well as a water-soluble compound containing at least one metal selected from the group consisting of monovalent, divalent, and trivalent metals (hereinafter simply referred to as a “water-soluble metal compound”). The water-soluble, non-transparent layer is preferably formed by drying an aqueous solution comprising a water-soluble cellulose derivative, as well as at least one metal ion selected from the group consisting of monovalent, divalent, and trivalent metal ions to solidify the aqueous solution into a film or a sheet. Although the water-soluble, non-transparent layer is non-transparent and exhibits hiding power in its dry state, once it contacts water or water vapor and is saturated with water, it becomes transparent due to a decrease in its hiding power. The indicator of the present invention visually indicates moisture by utilizing this phenomenon.

Although the reasons for this phenomenon are not necessarily clear, it can be explained, for example, as follows. The invention, however, is not limited by such a theory in any way.

When a cellulose molecule coexists with a monovalent, divalent, or trivalent metal ion in an aqueous solution, the hydroxy groups (or oxygen) in the cellulose molecule interact with the monovalent, divalent, or trivalent metal ion to form a kind of crosslinks inside the cellulose molecule or between molecules via the monovalent, divalent, or trivalent metal ion (the aqueous solution becomes transparent). When the transparent solution is dried, a polymer cellulose film is formed, while at the same time an aggregate of the cellulose and monovalent, divalent, or trivalent metal is formed to cause a scattering of light, resulting in the dry film having a white color (a non-transparent dry film is formed). When the resulting dry white film (non-transparent, dry film) contacts water or water vapor and is saturated with water, the bond of the aggregate loosens and the dry film turns into a transparent solution.

Examples of the water-soluble cellulose derivative for use in the invention include cellulose ethers substituted with at least one of alkyl or hydroxyalkyl groups. “Alkyl groups” designated by the alkyl or hydroxyalkyl groups include C₁-C₆, and preferably C₁-C₄, straight or branched chain lower alkyl; and more specifically, methyl, ethyl, butyl, and propyl. Specifically, examples of the water-soluble cellulose derivative include lower alkyl celluloses such as methyl cellulose and ethyl cellulose; hydroxy lower alkyl celluloses such as hydroxyethyl cellulose and hydroxypropyl cellulose; lower alkyl hydroxy alkyl celluloses such as hydroxyethyl methylcellulose, hydroxyethyl ethylcellulose, and hydroxypropyl methylcellulose; and cellulose-based, water-soluble polymers such as hydroxypropylmethylcellulose phthalate, hydroxypropylmethylcellulose acetate phthalate, and carboxymethylethyl cellulose. Preferable among these are methyl cellulose, hydroxypropyl cellulose, and hydroxypropyl methylcellulose, with hydroxypropyl methylcellulose being particularly preferable.

The water-soluble cellulose derivative for use in the invention may be any that does not prevent the kinematic viscosity of the solution from becoming 40 to 40,000 mm²/s when forming a film or a sheet. As long as this requirement is satisfied, a wide range of commercially available water-soluble cellulose derivatives can be used. As long as the above requirement is satisfied, the aforementioned water-soluble cellulose derivatives may be used not only singly but also in combination. Commercially available water-soluble cellulose derivatives, in general, have the ratio of weight average molecular weight (Mw) to number average molecular weight (Mn) (Mw/Mn) in the range of 1.5 to 4. Both the weight average molecular weight (Mw) and the number average molecular weight (Mn) for calculating the ratio (Mw/Mn) can be determined by gel chromatography (size-exclusion chromatography). Although the principle and procedure of gel chromatography are not limited, reference can be made to, for example, “Size-Exclusion Chromatography” of the section “Chromatography” in “USP 30 the United States Pharmacopeia/NF25 the National Formulary”.

Examples of the monovalent, divalent, or trivalent metals include monovalent metals such as sodium and potassium; divalent metals such as calcium, magnesium, manganese, iron, zinc, titanium, cobalt, nickel, copper, strontium, and barium; and trivalent metals such as aluminum and iron. Sodium and potassium are preferred as monovalent metals; calcium, magnesium, manganese, iron, cobalt, nickel, copper, strontium, and barium are preferred as divalent metals; and aluminum is preferred as a trivalent metal.

The water-soluble metal compound for use in preparing a water-soluble, non-transparent layer (a water-soluble, non-transparent film or sheet) is not particularly limited as long as it dissolves in water, an organic solvent, or a mixture thereof to release any of the aforementioned monovalent, divalent, or trivalent metal ions. Specifically, examples of the water-soluble metal compound include an oxide, a hydroxide, an inorganic salt, and an organic acid salt of any of the aforementioned monovalent, divalent, or trivalent metals. These metal compounds may be used singly or in combination. A water-soluble compound containing a water-soluble monovalent, divalent, or trivalent metal is preferred. The water-soluble metal compound used may be a solvate such as a hydrate.

Inorganic acids of monovalent, divalent, or trivalent metals include fluorides, chlorides, bromides, carbonates, hydrogen carbonates, phosphates, hydrogen phosphates, monohydrogen phosphates, dihydrogen phosphates, hydroxides, silicates, sulfates, hydrogen sulfates, nitrates, and the like of the aforementioned monovalent, divalent, or trivalent metals. Preferable are chlorides, carbonates, phosphates, and sulfates, with chlorides, sulfates, and carbonates being particularly preferable.

Examples of organic acid salts of monovalent, divalent, or trivalent metals include acetates, citrates, tartrates, pantothenates, gluconates, succinates, glycerophosphates, saccharates, stearates, ascorbates, lactates, and the like of the aforementioned monovalent, divalent, or trivalent metals. Preferable are lactates and gluconates. The saccharic acid for the saccharates means carboxylic acid obtained by formal oxidation of aldose to an aldehyde group.

The water-soluble, non-transparent layer (a water-soluble, non-transparent film or sheet) is basically prepared using the aforementioned water-soluble cellulose derivative and water-soluble metal compound, but may be blended with various additives, such as, for example, plasticizers, sequestrants, flavorants, and colorants, as required.

Examples of plasticizers include, but are not limited to: dioctyl adipate, polyester adipate, epoxidized soybean oil, epoxyhexahydrophthalate diesters, kaolin, triethyl citrate, glycerol, glycerol fatty acid esters, acetyl glycerol fatty acid esters, sesame oil, dimethylpolysiloxane-silicon dioxide mixture, D-sorbitol, medium chain fatty acid triglyceride, corn starch-derived sugar alcohol solutions, triacetin, concentrated glycerol, castor oil, phytosterol, diethyl phthalate, dioctyl phthalate, dibutyl phtalate, butyl phthalyl butyl glycolate, propylene glycol, polyethylene glycol, polyoxyethylene (105) polyoxypropylene (5) glycol, polysorbate 80, polyethylene glycols with average molecular weights of 1500, 400, 4000, 600, and 6000 (PEG 1500, PEG 400, PEG 4000, PEG 600, and PEG 6000), isopropyl myristate, cotton seed oil-soybean oil mixture, glyceryl monostearate, and isopropyl linolate. The average molecular weights of PEGs can be determined in accordance with the following testing methods as defined in the “Japanese pharmacopoeia” and “Japanese Pharmaceutical Excipients”, prescribed by the Ministry of Health, Labour and Welfare.

### (Average Molecular Weight Test)

42 g of phthalic anhydride is added to a 1-L light-resistant containing exactly 300 mL of newly distilled pyridine, and the phthalic anhydride is dissolved with vigorous shaking, after which the mixture is allowed to stand for 16 hours or longer. Exactly 25 mL of the resulting solution is measured out into about a 200-mL pressure-resistant, stoppered bottle. About from 0.8 to 12.5 g of the PEG sample to be measured is precisely measured and added to the stoppered bottle, the bottle is tightly sealed and wrapped with a strong cloth, and then placed in a water bath preheated at 98±2° C., to the level so that the mixture in the bottle soaks completely in water. After being kept at 98±2° C. for 30 minutes, the bottle is removed from the water bath and allowed to cool to room temperature in air. Exactly 50 mL of 0.5 mol/L sodium hydroxide solution is then added to the bottle, followed by the addition of five drops of a solution of phenolphthalein in pyridine (1 in 100), and the resulting solution is titrated with 0.5 mol/L sodium hydroxide solution until a light red color remains for not less than 15 seconds. A blank test is conducted in the same manner.

Average molecular weight=(quantity of sample (g)×4000)/(a−b) [Equation 1]

a: Amount (mL) of the 0.5 mol/L sodium hydroxide solution consumed in the blank test
b: Amount (mL) of the 0.5 mol/L sodium hydroxide solution consumed in the PEG sample test

A sequestrant may be used, such as ethylenediaminetetraacetic acid, acetic acid, boric acid, citric acid, gluconic acid, lactic acid, phosphoric acid, tartaric acid, or a salt thereof; or meta-phosphate, dihydroxyethyl glycine, lecithin, or beta cyclodextrin, or a combination thereof.

The colorant is not particularly limited, but is preferably a colorant that does not prevent the indicator from becoming transparent when it is saturated with water.

A gelling agent may also be used as required. Examples of a gelling agent for use in the invention include carrageenan, tamarind seed polysaccharide, pectin, xanthan gum, locust bean gum, curdlan, gelatin, furcellaran, agar, and gellan gum. These gelling agents can be used singly or in combination. Three types of carageenans are known in general, i.e., kappa-carageenan, iota-carageenan, and lambda-carageenan. In the invention, kappa- and iota-carageenans with a gelling ability can suitably be used. Pectins can be classified into LM pectin and HM pectin according to the esterification degree; and gellan gums can also be classified into acylated gellan gum (native gellan gum) and deacylated gellan gum, depending on whether they are acylated or not; but all such pectins and gellan gums can be used herein regardless of the type.

When a gelling agent is used, a co-gelling agent can also be used according to the type of the gelling agent used. When carageenan is used as a gelling agent, examples of co-gelling agents that can be used together include: for kappa-carageenan, compounds capable of donating in water one or more types of ions from the potassium ion, ammonium ion, and calcium ion, such as, for example, potassium chloride, ammonium chloride, ammonium acetate, and calcium chloride; and for iota-carageenan, compounds capable of donating the calcium ion in water, such as, for example, calcium chloride. When gellan gum is used as a gelling agent, examples of co-gelling agents that can be used together include compounds capable of donating in water one or more types of ions from the sodium ion, potassium ion, calcium ion, and magnesium ion, such as, for example, sodium chloride, potassium chloride, calcium chloride, and magnesium sulfate. In addition, an organic acid, or a water-soluble salt thereof, such as citric acid or sodium citrate can also be used.

When hydroxypropyl methylcellulose is used as a water-soluble cellulose derivative, carageenan and potassium chloride can be mentioned, respectively, as suitable examples of the gelling agent and co-gelling agent used together.

The water-soluble, non-transparent layer (a water-soluble, non-transparent film or sheet) can be produced in accordance with a common method for forming films or sheets. An example of such a method includes dissolving a water-soluble cellulose derivative and a water-soluble metal compound, as well as various additives or a gelling agent and/or a co-gelling agent, as required, in a solvent such as water; extending the resulting mixture into a film or a sheet; and drying the mixture by removing the solvent to solidify the mixture, thereby preparing a non-transparent film. The solvent is not limited to water, and may be an organic solvent, for example, an alcohol such as ethyl alcohol or methyl alcohol, an ether such as diethyl ether or dimethyl ether, a ketone such as acetone, or a solution mixture thereof. The solvent is preferably water, ethyl alcohol, methyl alcohol, or a mixture thereof.

To produce the water-soluble, non-transparent layer (a water-soluble, non-transparent film or sheet), the proportion of each component contained in the solution for use in forming a film or a sheet is preferably in a range that does not prevent the kinematic viscosity of the solution from becoming 40 to 40,000 nm²/s when forming a film or a sheet. Examples of such ranges include, but are not limited to, for a water-soluble cellulose derivative, from 1 to 60% by weight, preferably from 5 to 50% by weight, and more preferably from 10 to 30% by weight; and for a water-soluble metal compound, from 0.06 to 30% by weight, preferably from 0.25 to 20% by weight, and more preferably from 0.3 to 10% by weight. When the water-soluble metal compound used is a solvate, the proportion of the metal compound is a value calculated as the amount of the non-solvate. The proportion of the water-soluble metal compound (for a solvate, calculated as the amount of the non-solvate) with respect to 100 parts by weight of the water-soluble cellulose derivative contained in the solution may preferably range from 0.05 to 150 parts by weight, preferably from 0.1 to 100 parts by weight, more preferably from 0.2 to 40 parts by weight, and still more preferably from 1 to 20 parts by weight.

As stated above, the kinematic viscosity of the solution when forming a film or a sheet, in general, ranges from 40 to 40,000 mm²/s, preferably from 90 to 22,000 μm²/s, more preferably from 350 to 22,000 mm²/s, and still more preferably from 5,000 to 15,000 nm²/s. The kinematic viscosity as defined in the invention can be measured in accordance with the method described in Reference Experimental Example 2.

The water-soluble, non-transparent layer (a water-soluble, non-transparent film or sheet) may be produced using the method described above, i.e., by casting the solution containing the aforementioned components into a film or a sheet, and solidifying the solution by drying (solution casting or casting); however, other methods, such as calendering, extrusion, T-die molding, and inflation molding can also be used in accordance with conventional methods for producing general films or sheets.

Specifically, one example of a method includes dissolving a water-soluble metal compound in water heated to about 70 to 80° C.; dispersing a water-soluble cellulose derivative in the solution; cooling the dispersion to about 40 to 50° C. and dissolving the cellulose derivative to obtain a gel-like material (preferably with a kinematic viscosity of from 40 to 40,000 mm²/s), and extending (casting) the material on a flat plate into a film or a sheet; and drying the material by heating to solidify the material. In addition, utilizing the fact that a water-soluble cellulose derivative forms a gel at a temperature of 60° C. or higher, a method can also be used that includes extending (casting) the cooled solution on a flat plate heated to 60° C. or higher into a film or a sheet to cause the solution to gel, and simultaneously drying the gel by heating to solidify the gel. When a gelling agent and a co-gelling agent are used in addition to the water-soluble cellulose derivative, such a solution is allowed to gel by cooling. Therefore, a method can be used that includes extending (casting) the solution on a cooled flat plate into a film or a sheet, or cooling the solution after being extended to form a gel, and subsequently drying the gel by heating to solidify the gel.

The heating temperature employed for drying and solidification may typically be 50° C. or higher, and preferably 60° C. or higher. The upper limit of the heating temperature is not particularly limited, but may typically be 150° C., preferably 100° C., and more preferably from 60 to 100° C.

During the above-described manufacturing, the thickness (film thickness) of the water-soluble, non-transparent layer (a water-soluble, non-transparent film or sheet) can be suitably adjusted when molded into a film or a sheet. The thickness of the water-soluble, non-transparent layer (a water-soluble, non-transparent film or sheet) may typically be 5 μm or more, preferably from 20 to 2,000 μm, and more preferably from 20 to 500 μm. As explained below, the greater the thickness of the water-soluble, non-transparent layer (a water-soluble, non-transparent film or sheet), the longer the time required for the non-transparent layer to become transparent when contacting water or water vapor and is saturated with water: hence, there is a favorable correlation between the film thickness and the time required for the layer to become transparent when saturated with water. Therefore, the film thickness can be set suitably in view of the time required for the layer to become transparent when saturated with water.

The non-transparent, dry film composition for use in the invention has the feature of being non-transparent in its dry state. The non-transparency of the dry film composition can be evaluated based on the light transmittance of the dry film composition. Specifically, whether the dry film composition is non-transparent or not can be determined by measuring the light transmittance of the composition when irradiated with light as the lightness (the value L) using a spectrophotometer, in accordance with the method described below. In this case, as shown in the Reference Examples below, the transparency gradually decreases as the value of the lightness (the value L) of the film composition decreases to 90 or lower, and the composition becomes non-transparent at 70 or lower. Therefore, the non-transparent, dry film composition of the invention has a lightness (a value L) of 70 or lower, and preferably 65 or lower, as measured under the following conditions.

### Evaluation of the Degree of Non-Transparency

(1) The dry film composition to be tested is set on a cell holder and irradiated with light using a halogen lamp (standard light: D₆₅/10), and the lightness (the value L) of the film is measured using a spectrophotometer (manufactured by Nippon Denshoku Industries Co., Ltd., SE-2000 Model).

(2) Assuming that the lightness (the value L) of the composition is measured in the same manner as described above without setting the dry film composition on a cell holder to be 100, the lightness (the value L) determined in step (1) is calculated as the ratio with respect to that value.

The indicator portion (the display portion) of the moisture indicator of the invention may comprise only the water-soluble, non-transparent layer (a water-soluble, non-transparent film or sheet), or may further comprise a water-soluble transparent layer formed on at least one surface of the water-soluble, non-transparent layer. A water-insoluble support layer, and preferably a waterproof layer (a water-resistant layer), may further be formed on the water-soluble, non-transparent layer.

The water-soluble transparent layer formed on at least one surface of the water-soluble, non-transparent layer may be a water-soluble, transparent film or sheet made from a water-soluble film base. Examples of the water-soluble film base include known water-soluble film bases such as: cellulose-based polymers such as methyl cellulose, ethyl cellulose, methylhydroxyethyl cellulose, hydroxypropylcellulose, hydroxypropyl methylcellulose, hydroxypropylmethylcellulose phthalate, hydroxypropyl methylcellulose acetate succinate, and carboxy methyl ethyl cellulose; synthetic polymers such as polyvinyl acetal diethylaminoacetate, aminoalkyl methacrylate copolymer E (EUDRAGIT E (trade name) by Rohm Pharma), ethyl acrylate-methyl methacrylate copolymer (EUDRAGIT NE (trade name) by Rohm Pharma), polyvinyl alcohol, polylactic acid, and polyvinyl pyrrolidone; polysaccharides such as pullulan, alginic acid, dextrin, mannitol, chitosan, and hemicellulose; and acrylic polymers such as methacrylic acid copolymer L (EUDRAGIT L (trade name) by Rohm Pharma). These water-soluble film bases may be used singly or in combination. Any of the aforementioned methods, such as solution casting (casting), calendering, extrusion, T-die molding, and inflation molding can be used to mold the water-soluble transparent layer into a film or a sheet; but a preferred method is one in which a solution containing the water-soluble film base is extended into a film or a sheet on a flat plate, and the film base is solidified by drying.

In addition to the water-soluble film base, the solution for forming the water-soluble transparent layer may be blended with various additives (for example, plasticizers, sequestrants, flavorants, and colorants), a gelling agent, and/or a co-gelling agent, as required.

The moisture indicator with a water-soluble transparent layer formed on at least one surface of a water-soluble, non-transparent layer can be made by forming the water-soluble transparent layer (a water-soluble transparent film or sheet) that has been made into a film or a sheet in the manner described above onto the water-soluble, non-transparent layer (a water-soluble, non-transparent film or sheet) prepared separately in the manner described above, and by attaching these layers to each other. The water-soluble transparent layer may be attached to the water-soluble, non-transparent layer by, for example, applying an alcohol solution of a water-soluble polymer to both or one of the surfaces of the water-soluble transparent layer and the water-soluble, non-transparent layer to be attached, and then bonding these layers.

Alternatively, the solution containing the water-soluble film base may be applied onto a surface of the prepared water-soluble, non-transparent layer (a water-soluble, non-transparent film or sheet) and extended (cast) into a film or a sheet, and the solution may be solidified by drying.

The thickness of the water-soluble transparent layer (a water-soluble transparent film or sheet) is not particularly limited, but can be suitably set or adjusted to typically 5 μm or more, preferably from 20 to 2,000 μm, and more preferably from 20 to 500 μm. The water-soluble transparent layer serves to prevent direct contact of the water-soluble, non-transparent layer with water or water vapor, and delay the time required for the water-soluble, non-transparent layer to become transparent when saturated with water. In addition, the delay time can be controlled by adjusting the thickness of the water-soluble transparent layer, as described in Experimental Example 4 below. The thickness of the water-soluble transparent layer can thus be set suitably in view of the time required for the water-soluble, non-transparent layer to become transparent when saturated with water.

When the moisture indicator of the invention has a water-insoluble support layer, the support layer is attached to the water-soluble, non-transparent layer. When the moisture indicator has both the water-soluble, non-transparent layer and the water-soluble transparent layer, the support layer is attached to the water-soluble, non-transparent layer. Examples of the method for producing this moisture indicator include, but are not limited to, the following: a method in which a film or a sheet formed of a water-soluble, non-transparent layer, or a two-layer film or sheet formed of a water-soluble transparent layer and a water-soluble, non-transparent layer, are prepared separately, and these films or sheets are attached to a support layer (in the case of the two-layer film or sheet, the water-soluble, non-transparent layer is formed on the support layer so as to be positioned on the inner side of the moisture indicator; a method in which a solution containing the components for forming a water-soluble, non-transparent layer is applied to a surface of the support layer and extended into a film or a sheet, and the solution is dried and solidified; and a method in which a solution containing the components for forming a water-soluble, non-transparent layer is applied to a surface of the support layer and extended into a film or a sheet, and the solution is dried and solidified, after which a solution containing the film base for forming a water-soluble transparent layer is applied on the water-soluble, non-transparent layer and extended into a film or a sheet, and the solution is dried and solidified.

The material for the water-insoluble support layer is not particularly limited as long as it is water-insoluble, and preferably waterproof or water-resistant. Examples of the material include synthetic resins such as polyethylene, polypropylene, and polyethylene terephthalate; and laminated paper.

The support layer (preferably a waterproof layer) may be dyed any color, or may have desired letters or a design printed thereon. In this way, when the water-soluble, non-transparent layer has become saturated with water and transparent, the color or print on the support layer will appear, allowing one to visually recognize the moisture clearly.

The support layer (preferably a waterproof layer) may also be transparent. In this way, when the water-soluble, non-transparent layer has become saturated with water and transparent, the moisture indicator will become transparent itself. In this case, a portion of the transparent support layer may be dyed, or have desired letters or a design printed thereon. When a portion of the transparent support layer is dyed or printed, the color or print on the support layer will appear when the water-soluble, non-transparent layer has become saturated with water and transparent, allowing one to visually recognize the moisture.

When the support layer (preferably a waterproof layer) is transparent, a pigment with hiding power or resistance to water may be used for a portion of the moisture indicator, so as to provide a region that does not become transparent when saturated with water (a region that does not become transparent by contact with water). In this case, the moisture indicator has a transparent region and a non-transparent region when the water-soluble, non-transparent layer is saturated with water, allowing one to visually recognize the moisture.

The non-transparent region (the region that does not become transparent by contact with water) can be formed by dyeing, or by printing desired letters or a design on, a portion of the water-soluble, non-transparent layer, using a pigment with hiding power or resistance to water.

The moisture indicator of the invention can further comprise an attachment layer for easy use in attaching the indicator to a test target, enabling the indicator to be prepared as a seal-type indicator. The attachment layer is a layer with the function of attaching the moisture indicator to a test target, and can have an adhesion layer formed by applying, for example, a pressure sensitive adhesive. Preferably, the adhesion layer is covered with a release paper until immediately before use so as not to adhere to other regions, and is adhered to a test target by peeling the release paper when used. The attachment layer is formed on the opposite side to the surface of the indicator that comes into contact with water.

### II. Time Indicator and Application Thereof

As described above, although the moisture indicator is non-transparent in its dry state, once it has come into contact with water or water vapor and become saturated with water, the indicator becomes transparent to visually indicate the moisture, utilizing the function of its water-soluble, non-transparent layer. In addition, depending on the thickness of the water-soluble, non-transparent layer, and when the water-soluble transparent layer is formed on the water-soluble, non-transparent layer, the moisture indicator is capable of controlling the time required for the water-soluble, non-transparent layer to become transparent when saturated with water, according to the total thickness of the water-soluble, non-transparent layer and the water-soluble transparent layer (see Experimental Examples 3 to 5).

The moisture indicator of the invention can thus be used as a time indicator for showing that a predetermined time has been reached. That is to say, the present invention provides use of the moisture indicator as a time indicator as another application.

The time indicator of the invention comprises the above-described structure of the moisture indicator as it is. Specifically, embodiments of the time indicator include:

(1) a time indicator having a water-soluble, non-transparent layer formed of a non-transparent, dry film composition, the composition comprising a water-soluble cellulose derivative, as well as a water-soluble compound containing at least one metal selected from the group consisting of monovalent, divalent, and trivalent metals;

(2) a time indicator further having a water-soluble transparent layer formed on at least one surface of the water-soluble, non-transparent layer formed of a non-transparent, dry film composition, the composition comprising a water-soluble cellulose derivative, as well as a water-soluble compound containing at least one metal selected from the group consisting of monovalent, divalent, and trivalent metals;

(3) a time indicator further having a water-insoluble support layer formed on the water-soluble, non-transparent layer of the time indicator of (1) or (2); and

(4) a time indicator further having an attachment layer (and preferably an additional release paper) formed on the water-soluble, non-transparent layer of the time indicator of (1) or (2), or on the water-insoluble support layer of the time indicator of (3).

The time indicator is used by bringing the water-soluble, non-transparent layer into contact with water or water vapor, and is configured to allow one to visually recognize the passage of time after the contact with water or water vapor, based on the water-soluble, non-transparent layer becoming transparent when saturated with water. The time indicator having a water-soluble transparent layer formed on the water-soluble, non-transparent layer is used by bringing the water-soluble transparent layer side into contact with water or water vapor.

In addition, a portion of the time indicator may be provided with a region that does not become transparent when saturated with water (a region that does not become transparent by contact with water), using a pigment with hiding power or resistance to water. This results in a transparent region and a non-transparent region being formed in the time indicator when the water-soluble, non-transparent layer is saturated with water. This allows one to visually check the passage of time after the time indicator has come into contact with water or water vapor. The non-transparent region (the region that does not become transparent by contact with water) can be formed by, for example, dyeing, or by printing desired letters or a design on, a portion of the water-soluble, non-transparent layer, using a pigment with hiding power or resistance to water.

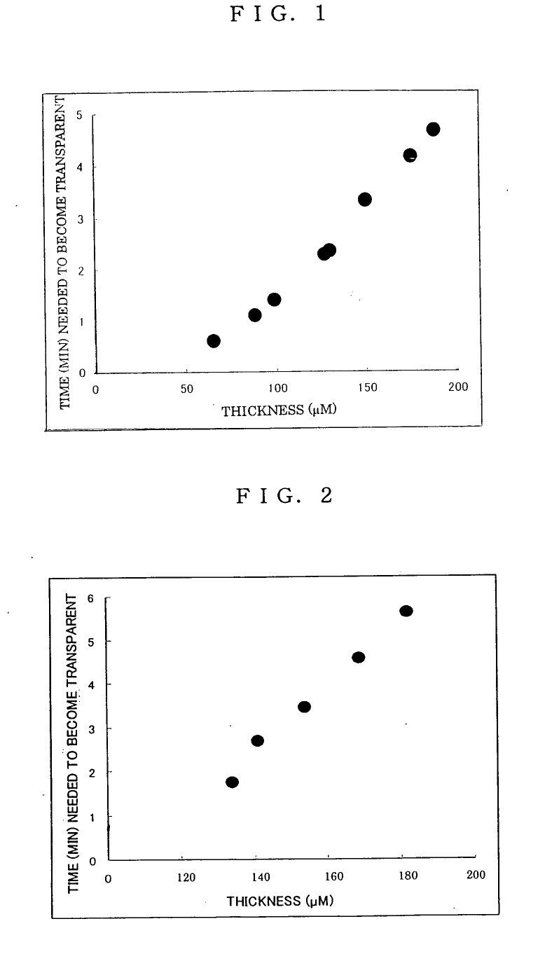

The thickness of the water-soluble, non-transparent layer, or the total thickness of the water-soluble, non-transparent layer and the water-soluble transparent layer when the water-soluble transparent layer is formed on the water-soluble, non-transparent layer can be set suitably according to the desired time. For example, when the water-soluble transparent layer and the water-soluble, non-transparent layer are both prepared using a water-soluble cellulose derivative, the total thickness thereof can be set with reference to Experimental Example 3 (FIG. 1) and Experimental Example 4 (FIG. 2).

Furthermore, the present invention provides containers having a portion provided with these time indicators, and container-packaged foods (foods kept in containers) in which foods are stored in these containers.

Examples of container-packaged foods include instant foods cooked by adding hot water, such as noodles packaged in cups and soups packaged in cups, foods packaged in retort pouches, etc.

For example, when a time indicator, in which the time required for becoming transparent when saturated with water is set to 3 minutes, is attached to the lid of the container of an instant food cooked by adding hot water such as noodles packaged in a cup, the user may pour hot water into the container and place the lid on, and at the same time drop water (hot water) onto the surface of the time indicator attached on the lid; the time indicator will then become transparent 3 minutes after the water is dropped onto it. When the time indicator has thus become transparent, the background (the display of the container) hidden under the time indicator (before it becomes transparent) appears, thereby indicating (allowing one to visually recognize) that the instant food has been prepared. When a time indicator having a support layer that is dyed or printed is used, the color or colored print of the support layer appears when the water-soluble, non-transparent layer has become transparent when saturated with water, thereby indicating (allowing one to visually recognize) that the instant food has been prepared.

When the time indicator of the invention is placed on the inside of the lid of an instant food cooked by adding hot water such as noodles packaged in a cup, one may pour hot water into the container and place the lid on, then the water-soluble, non-transparent layer will become saturated with the water vapor and become transparent. If a time indicator with a transparent support layer is used at that time, the time indicator itself will become transparent when saturated with water, allowing the contents of the container to be seen from the outside, thereby indicating (allowing one to visually recognize) that the instant food has been prepared. When the time indicator is partially provided with a dyed or printed region that does not become transparent, then the color or printed region will appear when the time indicator has become transparent when saturated with water, thereby showing (allowing one to visually recognize) that the instant food has been prepared.

In the case of a food packaged in a retort pouch having a time indicator in its pull tab or the like on one end, the user may put the retort pouch into boiling water so that the time indicator portion (the pull tab) is not immersed in the hot water, and at the same time drop hot water onto the time indicator portion (the pull tab). This allows one to visually recognize the passage of a predetermined length of time necessary to heat the contents based on a change in the time indicator portion.

### EXAMPLES

The present invention is described in greater detail below with reference to Experimental Examples and Examples, but the invention is not limited to these Examples.

### Reference Experimental Example 1

Using a spectrophotometer (manufactured by Nippon Denshoku Industries Co., Ltd., SE-2000 Model), various films of hydroxypropyl methylcellulose (HPMC) with different degrees of transparency were set on cell holders, and irradiated with light (D₆₅/10) using a halogen lamp to measure the lightness (the value L) of each film. As a control experiment, no film was set on a cell holder, and the lightness (the value L) was similarly measured by directing light in the same manner. Assuming the lightness (the value L) determined in the control experiment to be 100, the relative value of the lightness (the value L) determined for each film was calculated. Table 1 shows the lightness (the value L) and the degree of non-transparency (opaqueness) as visually evaluated for each film.

TABLE 1

| | Degree of | |
|---|---|---|
| | Non- | Appearance (Color) of |
| L Value for Each Film | Transparency | Film |
| 95.03 | − | Transparent Film |
| 90.54 | − | Transparent Film |
| 87.40 | ± | Pale White Film |
| 86.70 | ± | Pale White Film |
| 65.47 | + | White Film |
| 52.45 | ++ | White Film |
| 40.63 | ++ | White Film |
| 24.62 | ++ | White Film |
| 24.04 | ++ | White Film |
| 21.57 | ++ | White Film |
| 20.83 | ++ | White Film |
| 18.92 | ++ | White Film |
| 17.01 | ++ | White Film |
| 16.33 | ++ | White Film |
| 14.84 | ++ | White Film |
| 14.02 | ++ | White Film |
| 11.91 | ++ | White Film |
| 10.62 | ++ | White Film |

Degree of non-transparency:
−: completely transparent
±: somewhat transparent
+: somewhat non-transparent
++: completely non-transparent

These results show that the lightness (the value L) decreases as the light transmittance of the film decreases to increase the degree of non-transparency and the hiding power; hence, there is a positive correlation between the degree of transparency and lightness. These results have established that the non-transparent films exhibit lightness (value L) of 70 or lower, and preferably 65 or lower, as measured under the above-described conditions. The transparent films, on the other hand, exhibit lightness (value L) of 80 or higher, and preferably 90 or higher, as measured under the above-described conditions.

### Reference Experimental Example 2

Hydroxypropyl methylcellulose (HPMC) (weight average molecular weight: 60,000, Mw/Mn=1.9 (measured by gel chromatography; the same applies below), manufactured by Shin-Etsu Chemical Co., Ltd.) was placed into wide-mouthed bottles in amounts to yield the predetermined concentrations (3 to 18 wt %) shown in Table 3, and calcium chloride was added to each wide-mouthed bottle to yield a final concentration of 2%, after which hot water was added to make a total of 500 g.

Each container was then covered with a lid and the mixture was stirred using a stirrer at 350 to 450 revolutions per minute for 10 to 20 minutes, until a homogeneous dispersion was formed. The dispersion was dissolved while stirring it in a water bath at 10° C. or lower for 20 to 40 minutes, and the viscosity was measured. Viscosity was measured at 20±0.1° C. in accordance with the rotational viscometer method using a single cylindrical rotational viscometer (a Brookfield viscometer, LV Model), under the following conditions.

TABLE 2
(Operating Conditions)

| | | | Conversion |
|---|---|---|---|
| Viscosity (mPa · s) | Cylinder Number | Revolutions/min | Factor |
| 600 to less than | 3 | 60 | 20 |
| 1400 | | | |
| 1400 to less than | 3 | 12 | 100 |
| 3500 | | | |
| 3500 to less than | 4 | 60 | 100 |
| 9500 | | | |
| 9500 to less than | 4 | 6 | 1000 |
| 99500 | | | |
| 99500 or more | 4 | 3 | 2000 |

### (Operation of the Apparatus)

The single cylindrical rotational viscometer was operated and rotated for 2 minutes, after which the measurement on the viscometer was read, and the viscometer was stopped for 2 minutes. The same procedure was repeated, and the average of a total of three measurements (absolute viscosity: mPa·s) was determined.

The resulting solutions were degassed under reduced pressure, and allowed to stand at room temperature for 12 hours to obtain clear HPMC gels with different concentrations. The density (mass/volume) of each of the resulting HPMC gels was measured at 20±0.1° C. Each HPMC gel was cast on a glass, using an apparatus for preparing a thin-layer plate for thin-layer chromatography, to form a thin film of HPMC gel. The resulting thin films were then dried at 60 to 100° C. for 1 hour to prepare films with a thickness of about 120 μm.

Table 3 shows the results obtained by evaluating the kinematic viscosity (absolute viscosity/density; unit: mm²/s) and the film-forming ability (workability), as well as the degree of whiteness (non-transparency) of the resulting film, for each HPMC gel.

TABLE 3

| | Kinematic | | |
|---|---|---|---|
| HPMC | Viscosity | Degree of Whiteness | Film-Forming |
| Concentration | (mm^{2/}s) of | (Non-transparency | Ability |
| in HPMC Gel | HPMC Gel | and Hiding Power) | (Workability) |
| 3% | 40 | B | D |
| 4% | 90 | B | B |
| 6% | 350 | A | B |
| 8% | 1000 | A | B |
| 10% | 2500 | A | B |
| 12% | 5000 | A | A |
| 15% | 15000 | A | A |
| 16% | 22000 | A | B |
| 18% | 40000 | A | C |

Degree of whiteness (non-transparency and hiding power)
A: Excellent
B: Good
C: White but has low hiding power
Film-forming ability (workability)
A: Good
B: Capable of forming a film
C: Capable of forming a film, but requires a long degassing time when preparing a gel
D: Difficult to form a film due to low viscosity; but capable of preparing a film by using a mold or a spraying method

These results have established that the viscosity of the solution when forming a film is preferably in the range of 40 to 40,000 mm²/s, based on the relationship between the film-forming ability and the degree of whiteness of the resulting film. The viscosity is more preferably in the range of 90 to 22,000 mm²/s, still more preferably 350 to 40,000 mm²/s, and particularly preferably 5,000 to 15,000 mm²/s.

### Experimental Example 1

20 g of each of the water-soluble metal compounds shown in Table 4 was dissolved in 830 g of purified water heated to about 80° C., and 150 g of hydroxypropyl methylcellulose (HPMC) (weight average molecular weight: 60,000, Mw/Mn=1.9, manufactured by Shin-Etsu Chemical Co., Ltd.) was added to the solution while stirring to prepare a suspension. The resulting suspensions were dissolved by stirring at a temperature of 50° C. or lower, degassed under reduced pressure, and allowed to stand at room temperature for 12 hours to obtain clear HPMC gels (kinematic viscosity: 8,400 mm²/s). Using an apparatus for preparing a thin-layer plate for thin-layer chromatography, the resulting gels were cast on a glass plate to prepare thin films of HPMC gel, and then the thin films were dried at 60 to 100° C. for 1 hour to prepare films with a thickness of about 120 μm.

Table 4 shows the types of water-soluble metal compounds used, along with the results obtained by visually observing the degree of non-transparency for each resulting film. As a comparative sample, a film was similarly prepared without using a water-soluble metal compound (Not Used), and the film was evaluated in the same manner.

TABLE 4

| | |
|---|---|
| | Degree of Non-Transparency |
| Water-Soluble | at Drying Temperature |

| Metal Compound | 60° C. | 70° C. | 80° C. | 100° C. |
|---|---|---|---|---|
| MgCl₂•6H₂O | ++ | ++ | ++ | ++ |
| AlCl₃•6H₂O | ++ | ++ | ++ | ++ |
| MnCl₂•4H₂O | ++ | ++ | ++ | ++ |
| FeCl₂•4H₂O | ++ | ++ | ++ | ++ |
| CoCl₂ | ++ | ++ | ++ | ++ |
| NiCl₂ | ++ | ++ | ++ | ++ |
| CuSO₄•5H₂O | ++ | ++ | ++ | ++ |
| SrCl₂•6H₂O | ++ | ++ | ++ | ++ |
| BaCl₂•2H₂O | ++ | ++ | ++ | ++ |
| Not Used | − | − | − | − |

Degree of non-transparency
−: completely transparent
±: somewhat transparent
+: somewhat non-transparent
++: completely non-transparent

These results show that the HPMC gels comprising a water-soluble metal salt containing magnesium, aluminum, manganese, iron, cobalt, nickel, copper, strontium, or barium as a water-soluble metal compound became opaque by drying and solidifying the solution at a temperature of at least 60° C. or higher, and more specifically at 60 to 100° C., and were thereby prepared as films with hiding power and resistance to light.

### Experimental Example 2

Various amounts of magnesium chloride hexahydrate were dissolved in purified water heated to about 80° C. to yield the proportions shown in Table 5, and hydroxypropyl methylcellulose (HPMC) (weight average molecular weight: 60,000, Mw/Mn=1.9, manufactured by Shin-Etsu Chemical Co., Ltd.) was added to each solution while stirring to prepare suspensions. The resulting suspensions were dissolved while stirring at a temperature of 50° C. or lower and then degassed under reduced pressure, after which the solutions were allowed to stand at room temperature for 12 hours to obtain clear HPMC gels (kinematic viscosity: 8,000 mm²/s).

The weight ratios of magnesium chloride (calculated as anhydride) to HPMC used to prepare the HPMC gels are shown in Table 5. Each HPMC gel was cast on a glass plate, using an apparatus for preparing a thin-layer plate for thin-layer chromatography, to form a thin film of HPMC gel, and then the thin film was dried at 90° C. for 1 hour to prepare a film with a thickness of about 150 μm.

The strength of each of the resulting films was evaluated in accordance with the following method.

### Evaluation of Film Strength

Each film was cut into a rectangular strip (5×2 cm), the strip was folded with both ends aligned, and then the strip was spread back into its original state. The film was then rated as follows:

(1) A: the film completely recovers its original state
(2) B: the film is bent
(3) C: the film has bend lines remaining
(4) D: the film is broken

Table 5 gives the results of visually observing the degree of non-transparency and the appearance, as well as the film strength, for each of the resulting films.

TABLE 5

| Gel Composition | | | |
|---|---|---|---|
| (Weight | Degree of Non- | | |
| Ratio) | Transparency | Appearance (Color) | |
| HPMC:MgCl₂ | of the Film | of the Film | Film Strength |
| 100:1.0 | + | Pale White | A |
| 100:4.69 | ++ | White | A |
| 100:6.10 | ++ | White | A |
| 100:10 | ++ | White | A |
| 100:13 | ++ | White | A |
| 100:14.06 | ++ | White | A |
| 100:23.44 | ++ | White | A |
| 100:30 | ++ | White | A |
| 100:37.51 | ++ | White | A |
| 100:50 | ++ | White | A |
| 100:80 | ++ | White | B |
| 100:100 | + | Pale White | C |

Degree of non-transparency
−: completely transparent
±: somewhat transparent
+: somewhat non-transparent
++: completely non-transparent

The results of Table 5 show that non-transparent white films with high hiding power can be prepared by adding from 1 to 100 parts by weight of a water-soluble metal salt (magnesium chloride hexahydrate) to 100 parts by weight of HPMC.

### Experimental Example 3

30 g of calcium lactate was dissolved in 820 g of purified water heated to about 80° C., and 150 g of hydroxypropyl methylcellulose (HPMC) (weight average molecular weight: 60,000, Mw/Mn=1.9, manufactured by Shin-Etsu Chemical Co., Ltd.) was added into the solution while stirring to prepare a suspension. The resulting suspension was dissolved while stirring at a temperature of 50° C. or lower and then degassed under reduced pressure, after which the solution was allowed to stand at room temperature for 12 hours to obtain a clear HPMC gel (kinematic viscosity: 8500 mm²/s). The HPMC gel was cast on a glass plate, using an apparatus for preparing a thin-layer plate for thin-layer chromatography, to form a thin film of HPMC gel. The thin film was then dried at about 80° C. for 1 hour, and various white films (water-soluble, non-transparent layers) with a thickness of 65, 88, 99, 127, 130, 150, 175, or 188 μm were prepared (Examples 1 to 8).

25 μl of purified water was dropped onto the surface of each white film, and the time required for the white film to become transparent was measured. The results are shown in FIG. 1.

As shown in FIG. 1, all of the white films prepared above became transparent when saturated with water, and the time required for each film to become transparent after water was dropped onto it was closely correlated with the thickness of the film (film thickness).

This shows that the white film of the present invention can be used as a “moisture indicator” to indicate moisture, and can also be used as a “time indicator” to indicate the passage of time because the time required for the time indicator to become transparent when saturated with water can be set as desired by adjusting the thickness of the film. In the case of the above-described white films, by adjusting their thickness to about 140 μm, about 175 μm, or about 200 μm, they become transparent after 3, 4, or 5 minutes, respectively, from their contact with water, thereby indicating (allowing the user to visually recognize) the passage of the time.

### Experimental Example 4

150 g of hydroxypropyl methylcellulose (HPMC) (weight average molecular weight: 60,000, Mw/Mn=1.9, manufactured by Shin-Etsu Chemical Co., Ltd.) was added while stirring into 850 g of purified water heated to about 80° C., to prepare a suspension. The resulting suspension was dissolved while stirring at a temperature of 50° C. or lower and then degassed under reduced pressure, after which the solution was allowed to stand at room temperature for 12 hours to prepare a clear HPMC gel (kinematic viscosity: 8,400 mm²/s). The HPMC gel was cast on a glass plate, using an apparatus for preparing a thin-layer plate for thin-layer chromatography, to form a thin film of HPMC gel. The thin film was then dried at about 80° C. for 1 hour, and colorless transparent films (water-soluble transparent layers) with a thickness of 34, 41, 54, 69, or 82 μm were prepared.

Each of the resulting colorless transparent films (water-soluble transparent layers) was placed on a white film (a water-soluble, non-transparent layer) with a thickness of about 100 μm prepared in the method described in the Experimental Example 3 above, and the two layers were bonded using a 10% ethanol solution of Plasdone S-630 (copolyvidone), which is a powder binder, to prepare two-layer films with various thicknesses (134 to 182 μm) (Examples 9 to 13).

25 μl of purified water was dropped onto the surface of the water-soluble transparent layer of each two-layer film, and the time required for the film (with a thickness of 134 to 182 μm) to become transparent was measured. The results are shown in FIG. 2.

As shown in FIG. 2, all of the two-layer films prepared above became transparent when saturated with water, and the time required for each film to become transparent was closely correlated with the thickness of the film. This shows that when the film comprises two layers, i.e., a white layer (a water-soluble, non-transparent layer) and a transparent layer (a water-soluble transparent layer), the time required for the white layer to become transparent when saturated with water can be set as desired by adjusting the thickness of the transparent layer.

That is to say, the two-layer films prepared above can be used as “moisture indicators” to indicate moisture. In addition, a predetermined time required for the non-transparent layer to become transparent when saturated with water can be set by adjusting the thickness of the water-soluble transparent layer, allowing the two-layer films to also be used as “time indicators” to indicate the passage of a predetermined length of time. In the case of the above-described two-layer films (the thickness of the white layer was 100 μm), by adjusting the thickness of the transparent layer to about 45, about 60, or about 75 μm, each film became transparent by water penetrating into the white layer after 3, 4, or 5 minutes, respectively, from its contact with water, thereby allowing one to visually recognize the passage of the time.

### Experimental Example 5

Magnesium chloride hexahydrate (MgCl₂.6H₂O) was used instead of the calcium lactate used in Experimental Example 3, and the resulting film was similarly dried at about 80° C. for 1 hour to prepare non-transparent films (water-soluble, non-transparent layers) with various thicknesses. The time required for each film to become transparent was then measured.

Specifically, 340 g of a 2.25% aqueous solution of magnesium chloride hexahydrate was heated to about 80° C., and 60 g of hydroxypropyl methylcellulose (HPMC) was added thereto to prepare a dispersion. The resulting dispersion was cooled to 30° C. while stirring to dissolve the HPMC, and the solution was degassed for a day under reduced pressure to prepare a HPMC gel (kinematic viscosity: 8,000 nm²/s). The resulting HPMC gel was cast on a glass plate, using an apparatus for preparing a thin-layer plate for thin-layer chromatography, to form a thin film of HPMC gel, and then the film was dried at about 100° C. for 1 hour to prepare various white films (water-soluble, non-transparent layers) with different thicknesses.

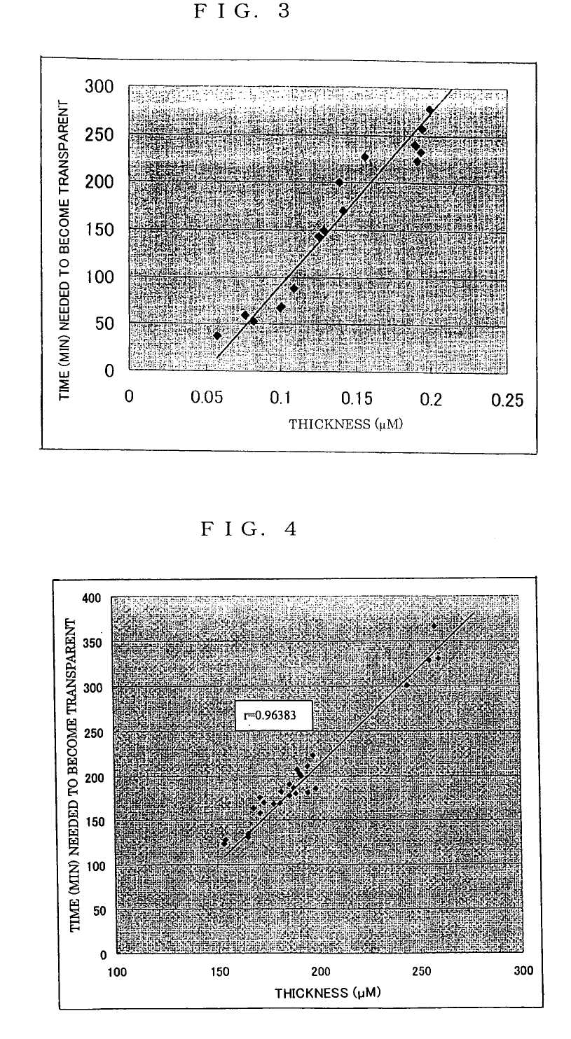

0.1 ml of purified water was dropped onto the surface of each white film, and the time required for the film to become transparent was measured. The results are shown in FIG. 3.

As shown in FIG. 3, all of the white films prepared above became transparent when saturated with water, and the time required for each film to become transparent after water was dropped onto it was closely correlated with the thickness of the film (film thickness).

### Experimental Example 6

Instead of the calcium lactate used in Experimental Example 3, sodium chloride (NaCl), potassium chloride (KCl), calcium chloride, magnesium chloride (MgCl₂.6H₂O), aluminium chloride (AlCl₃.6H₂O), manganese chloride (MnCl₂.4H₂O), ferric chloride (FeCl₂.4H₂O), cobalt chloride, nickel chloride, copper sulfate (CuSO₄.5H₂O), strontium chloride (SrCl₂.6H₂O), and barium chloride (BaCl₂.2H₂O) were used, and the resulting films were similarly dried at about 80° C. for 1 hour in the same manner to prepare non-transparent films (water-soluble, non-transparent layers).

25 μl of purified water was dropped onto the surface of each white film, and the time required for the non-transparent film to become transparent was measured. The results are shown in Table 6.

TABLE 6

| | | | | | Time (s) |
|---|---|---|---|---|---|
| | | | | | for the |
| | Degree of | | | Film | Film to |
| Water-Soluble Metal | Non- | Hiding | Appearance | Thickness | Become |
| Compound | Transparency | Power | (Color) | (mm) | Transparent |
| Sodium Chloride | ++ | Yes | White | 0.172 | 144 |
| (NaCl) | | | | | |
| Potassium Chloride | ++ | Yes | White | 0.153 | 175 |
| (KCl) | | | | | |
| Calcium Chloride | ++ | Yes | White | 0.153 | 123 |
| (CaCl₂) | | | | | |
| Magnesium Chloride | ++ | Yes | White | 0.175 | 100 |
| (MgCl₂•6H₂O) | | | | | |
| Aluminum Chloride | ++ | Yes | White | 0.138 | 158 |
| (AlCl₃•6H₂O) | | | | | |
| Manganese Chloride | ++ | Yes | White | 0.158 | 220 |
| (MnCl₂•4H₂O) | | | | | |
| Ferric Chloride | ++ | Yes | Dark | 0.125 | 190 |
| (FeCl₂•4H₂O) | | | Yellowish | | |
| | | | White | | |
| Cobalt Chloride | ++ | Yes | Dark | 0.150 | 210 |
| (CoCl₂) | | | Yellowish | | |
| | | | White | | |
| Nickel Chloride | ++ | Yes | Pale | 0.155 | 135 |
| (NiCl₂) | | | Yellowish | | |
| | | | White | | |
| Copper Sulfate | ++ | Yes | Pale | 0.135 | 390 |
| (CuSO₄•5H₂O) | | | Bluish | | |
| | | | White | | |
| Strontium Chloride | ++ | Yes | White | 0.174 | 250 |
| (SrCl₂•6H₂O) | | | | | |
| Barium Chloride | ++ | Yes | White | 0.102 | 144 |
| (BaCl₂•2H₂O) | | | | | |

Degree of Non-Transparency
−: completely transparent
±: somewhat transparent
+: somewhat non-transparent
++: completely non-transparent

Taking samples using calcium chloride as an example, the relationship between the thickness of each non-transparent film and the time required for the film to become transparent was examined, and the results are shown in FIG. 4.

The aforementioned results reveal that, as with the white films prepared in Experimental Examples 3 and 5 using calcium lactate or magnesium chloride as water-soluble metal compounds, all of the non-transparent films can be used as “moisture indicators” to indicate moisture. In addition, these films can also be used as “time indicators” to indicate the passage of time because the time required for the time indicator to become transparent when saturated with water can be set as desired by adjusting the thickness of the film.

Moreover, two-layer films as in Experimental Example 4 can be similarly prepared using these non-transparent films, and these films can also be used as “moisture indicators” and “time indicators”.

### Experimental Example 7

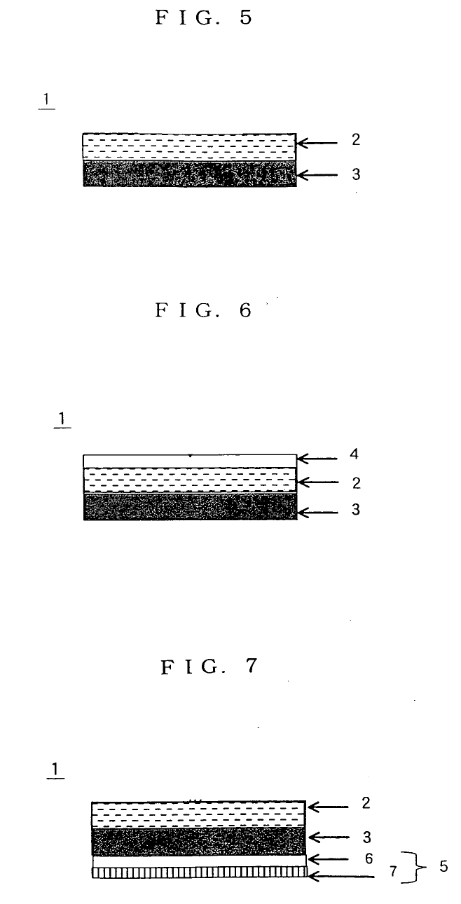

On each of the white films (water-soluble, non-transparent layers, reference numeral 2) prepared in Experimental Examples 3, 5, and 6, a color-printed, water-insoluble support layer (waterproof layer, reference numeral 3) was placed with its printed side facing inside, and the layers were bonded using a 10% ethanol solution of Plasdone S-630 (copolyvidone), which is a powder binder, to prepare time indicators (time display sheets) as shown in FIG. 5 (Examples 14 to 16). In addition, on the white layer (water-soluble, non-transparent layer, reference numeral 2) of each two-layer film prepared in Experimental Example 4, a color-printed, water-insoluble support layer (waterproof layer, reference numeral 3) was placed with its printed side facing inside, and the layers were bonded with a powder binder to prepare time indicators (time display sheets) as shown in FIG. 6 (Example 17).

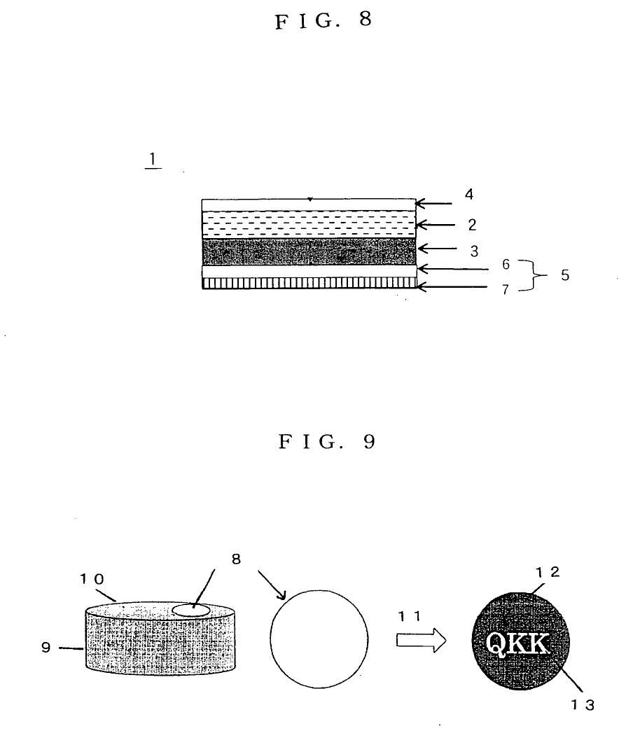

Furthermore, as shown in FIGS. 7 and 8, on the water-insoluble support layer (waterproof layer, reference numeral 3) of each of these time indicators (time display sheets), an attachment layer (reference numeral 6) was formed by application of a 10% ethanol solution of Plasdone S-630 (copolyvidone), and then the attachment layer (reference numeral 6) was covered with a release paper (reference numeral 7) to prepare seal-type time indicators (time display seals) (Examples 18 to 21).

When water was dropped onto or water vapor was passed to the surface of each of these time indicators (time display sheets) (the surface of the white layer (reference numeral 2) of the sheet shown in FIG. 5, or the surface of the transparent layer (reference numeral 4) of the sheet shown in FIG. 6), or the surface of each time display seal (the surface of the white layer (reference numeral 2) of the seal shown in FIG. 7, or the surface of the transparent layer (reference numeral 4) of the seal shown in FIG. 8), the white layer (reference numeral 2) became transparent when saturated with water after a certain period of time, accompanied by the appearance of the print on the waterproof layer. As can be seen from the results, these time display sheets and time display seals can be used effectively as simple time indicators.

For example, if any of these time display sheets or seals, in which the time required for it to become transparent when saturated with water is set to 3 minutes, is attached to the lid of the container of an instant food cooked by adding hot water (such as noodles packaged in a cup) (in the case of a two-layer film as prepared in Experimental Example 4, it is attached with the water-soluble transparent layer facing outside), then the user may pour hot water into the container and place the lid on, and simultaneously drop hot water onto the time display sheet or seal. This causes the time display sheet or seal to become transparent in 3 minutes after hot water is dropped onto it, causing the colored print on the support layer to appear, thereby indicating (allowing one to visually recognize) that the instant food has been prepared.

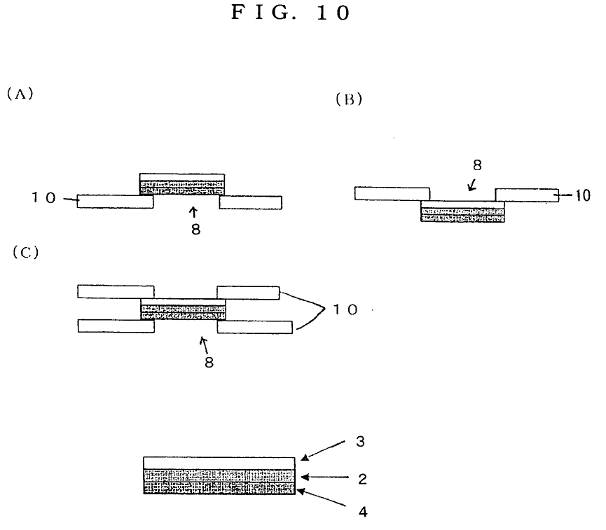

In addition, as shown in FIG. 9, if a window portion formed of any of these time display sheets (for example, those shown in FIGS. 5 and 6), in which the time required for it to become transparent when saturated with water is set to a predetermined time, is attached to the lid of the container of an instant food cooked by adding hot water (such as noodles packaged in a cup) (in the case of the time display sheet shown in FIG. 6, it is attached so that the support layer (reference numeral 3) faces outside, for example, with the water-soluble transparent layer (reference numeral 4) facing inside). The user may then add hot water to the container and place the lid on, causing the time display sheet on the lid to become transparent due to water vapor filling inside the container, which allows the inside of the container to be seen through the window portion (appearance), or which allows the colored print on the support layer to appear, thereby indicating (allowing one to visually recognize) that the instant food has been prepared.

FIG. 10 shows three embodiments of the structure of the lid. FIG. 10(A) shows an embodiment of the lid, in which the time display sheet of the invention (for example, the time display sheet shown in FIG. 6) is disposed on the exterior surface of the container lid, with the water-insoluble support layer (transparent layer, reference numeral 3) positioned on top (in other words, the support layer (reference numeral 3) positioned outside of the lid) (the time display sheet attached on the upper surface of the lid). FIG. 10(B) shows an embodiment of the lid, in which the time display sheet of the invention (for example, the time display sheet shown in FIG. 6) is disposed on the interior surface of the container lid, with the water-insoluble support layer (the transparent layer, reference numeral 3) positioned on top (in other words, the support layer (reference numeral 3) facing the outside of the lid) (the time display sheet attached on the lower surface of the lid). FIG. 10(C) shows an embodiment of the lid, in which the lid of the container is formed of a two-layer sheet, and the time display sheet (for example, the time display sheet shown in FIG. 6) is disposed between the sheets of the two-layer sheet, with the water-insoluble support layer (transparent layer, reference numeral 3) positioned on top (in other words, the support layer, (reference numeral 3) facing the outside of the lid) (the time display sheet attached between the sheets of the lid).

1. A moisture indicator having a water-soluble, non-transparent layer formed of a non-transparent, dry film composition, the composition comprising a water-soluble cellulose derivative, as well as a water-soluble compound containing at least one metal selected from the group consisting of monovalent, divalent, and trivalent metals.

2. A moisture indicator according to claim 1, wherein the water-soluble, non-transparent layer is a water-soluble, non-transparent layer formed by drying an aqueous solution comprising a water-soluble cellulose derivative, as well as at least one metal ion selected from the group consisting of monovalent, divalent, and trivalent metal ions to solidify the aqueous solution into a film or a sheet.

3. A moisture indicator according to claim 1, wherein a water-soluble transparent layer is formed on at least one surface of the water-soluble, non-transparent layer.

4. A moisture indicator according to claim 1, wherein a water-insoluble support layer is further formed on the water-soluble, non-transparent layer.

5. A moisture indicator according to claim 4, wherein the water-insoluble support layer is transparent.

6. A moisture indicator according to claim 4, wherein a portion or all of the water-insoluble support layer is dyed or printed.

7. A moisture indicator according to claim 5, which has a portion that does not become transparent when saturated with water.

8. A moisture indicator according to claim 1, wherein an attachment layer is further formed on the water-soluble, non-transparent layer.

9. A moisture indicator according to claim 4, wherein an attachment layer is further formed on the water-insoluble support layer.

10. A time indicator having a water-soluble, non-transparent layer formed of a non-transparent, dry film composition, the composition comprising a water-soluble cellulose derivative, as well as a water-soluble compound containing at least one metal selected from the group consisting of monovalent, divalent, and trivalent metals.

11. A time indicator according to claim 10, wherein the water-soluble, non-transparent layer is a water-soluble, non-transparent layer formed by drying an aqueous solution comprising a water-soluble cellulose derivative, as well as at least one metal ion selected from the group consisting of monovalent, divalent, and trivalent metal ions to solidify the aqueous solution into a film or a sheet.

12. A time indicator according to claim 10, wherein a water-soluble transparent layer is formed on at least one surface of the water-soluble, non-transparent layer.

13. A time indicator according to claim 10, wherein a water-insoluble support layer is further formed on the water-soluble, non-transparent layer.

14. A time indicator according to claim 13, wherein the water-insoluble support layer is transparent.

15. A time indicator according to claim 13, wherein a portion or all of the water-insoluble support layer is dyed or printed.

16. A time indicator according to claim 14, which has a portion that does not become transparent when saturated with water.

17. A time indicator according to claim 10, wherein an attachment layer is further formed on the water-soluble, non-transparent layer.

18. A time indicator according to claim 13, wherein an attachment layer is further formed on the water-insoluble support layer.

19. A time indicator according to claim 10, which is used by bringing water or water vapor into contact with the water-soluble, non-transparent layer, and which measures the passage of time after contacting water, based on the water-soluble, non-transparent layer becoming transparent by contact with water or water vapor.

20. A time indicator according to claim 12, which is used by bringing water or water vapor into contact with the water-soluble transparent layer, and which measures the passage of time after contacting water, based on the water-soluble, non-transparent layer becoming transparent by contact with water or water vapor.

21. A time indicator according to claim 15, wherein the dyed or printed surface of the water-insoluble support layer appears when the water-soluble, non-transparent layer has become transparent by contact with water or water vapor.

22. A container comprising the time indicator as defined in claim 10 in a portion thereof.

23. A food packaged in a container, in which a food is packaged in a container comprising the time indicator as defined in claim 10 in a portion thereof.

24. A food packaged in a container according to claim 23, which is an instant food cooked by adding hot water or a food in a retort pouch.
